(19) United States
(12) Patent Application Publication
(10) Pub. No.: US 2024/0351745 A1
(43) Pub. Date: Oct. 24, 2024

(54) BASE SYSTEM AND BEARING SYSTEM

(71) Applicant: Olaf BADER, Selm (DE)

(72) Inventor: Olaf BADER, Selm (DE)

(21) Appl. No.: 18/683,660

(22) PCT Filed: Aug. 26, 2022
(86) PCT No.: PCT/EP2022/073823

§ 371 Date: Feb. 14, 2024

(30) Foreign Application Priority Data
Aug. 27, 2021 (DE) 20 2021 104 634.1

(51) Int. Cl. B65D 21/06

(52) U.S. Cl. CPC B65D 21/064

(57) ABSTRACT

A base system for laying on at least two standardized small load carriers, in particular Euro containers, arranged on a flat underlying surface. The base system has at least two base panels with a substantially rectangular design, and each base panel is provided around the edges with connecting recesses and connecting protrusions which alternate at least indirectly and via which the base panels can be connected together in a formfitting manner along the edges. Mutually facing sides of respective base panels are designed to complement each other, wherein each base panel is provided around the edges with connection geometries which are identically designed and which directly adjoin each other around the edges.

### FIELD OF THE INVENTION

The invention relates to a base system for placing on at least two standardized small load carriers, particularly Euro boxes, arranged next to one another on a level surface, wherein the base system has at least two substantially rectangularly designed base plates, wherein each base plate is provided at the edges with connecting recesses and connecting projections alternating at least indirectly around its circumference, via which the base plates can be connected to one another at the edges in a form-fitting manner, wherein opposite sides of the respective base plate are designed complementary to one another, wherein each base plate is provided with connecting geometries all around the edge, which are designed identically and are directly adjacent to one another all around. The invention also relates to a storage system for storing objects, having at least two small load carriers which can be placed next to one another on a flat underground.

### BACKGROUND OF THE INVENTION

Standardized small load carriers are well known and are used to store objects. The small load carriers can be placed on a floor, a loading base of a vehicle or a shelf. Special standardized small load carriers are also known as Euro boxes, Euro standard containers or Euro standard boxes. These small load carriers are usually stackable.

DE 201 06 967 U1 relates to a folding container made of cardboard, paperboard or corrugated cardboard, with a base and at least largely vertical side walls, wherein a plate made of cardboard, paperboard or corrugated cardboard is attached under the base as a stacking protection, which has an undersize on the circumference compared to the base surface to ensure stackability. The plate can be an attachable or stand-alone lid in the area of the folding container opening. The folding container can have approximately the dimensions of a standardized Euro box.

DE 10 2009 044 527 A1 relates to a commercial vehicle with a loading space covering the rear wheels of the commercial vehicle, which has a substantially rectangular base surface which is interrupted by two wheel housings projecting inwards from opposite longitudinal sides of the base surface and spaced apart in the longitudinal direction of the commercial vehicle from a front and a rear transverse side of the base surface and in the transverse direction by a transverse distance. Standardized transport containers, particularly Euro boxes, can be placed on the base surface of the loading space, which can be at least partially covered with at least one cover plate forming an intermediate base.

### SUMMARY OF THE INVENTION

It is an object of the invention to improve the occupancy of a loading space with standardized small load carriers.

This function is achieved by the base system for placing on at least two standardized small load carriers arranged next to one another on a flat subsurface, in particular Euro containers, the base system comprising: at least two substantially rectangular base panels, wherein each base panel is provided with connection recesses and connection protrusions around the edge in an at least indirectly alternating manner, via which recesses and protrusions the base panels can be connected to one another at the edges in a form-fitting manner, mutually facing sides of the relevant base panel being designed to be complementary to one another, each base panel being provided with connection geometries around the edge, which geometries are identical and directly adjoin one another in a peripheral manner, and each connection geometry being formed by a first edge portion of the base panel, a connection recess, a connection protrusion, and a second edge portion of the base panel in this order, the connection recess of the relevant connection geometry directly adjoining the connection protrusion of said connection geometry; and a storage system for storing objects, comprising: at least two small load carriers which can be placed next to one another on a flat subsurface, and at least one base system. Advantageous embodiments are reproduced in the sub-claims, the following representation and the figures, wherein these embodiments can each represent an advantageous and/or additional aspect of the invention on their own or a combination of at least two of these embodiments with one another.

A base system according to the invention for placing on at least two standardized small load carriers, particularly Euro boxes, arranged next to one another on a flat underground, has at least two substantially rectangularly designed base plates, wherein each base plate is provided with connecting recesses and connecting projections on the peripheral side in at least indirect alternation, via which the base plates can be connected to one another on the peripheral side in a form-fitting manner, wherein opposite sides of the respective base plate are designed complementary to one another, wherein each base plate is provided with connecting geometries all around the edge, which are designed identically and are directly adjacent to one another all around, wherein each connecting geometry is formed by a first edge portion of the base plate, a connecting recess, a connecting projection and a second edge portion of the base plate, in that order, and wherein the connecting recess of the respective connecting geometry is directly adjacent to the connecting projection of this connecting geometry.

By means of the base system according to the invention, a base, particularly an intermediate base, can be formed on the small load carriers, on which objects, for example further small load carriers, can be placed. In addition, the base designed in this manner can be walked on in such a manner that accessibility to the load space is not impaired by the small load carriers placed on the load space base. This means that the load space partially occupied by the small load carriers can be used more optimally.

To form the base by means of the base system, the base plates are simply placed on the small load carriers and connected to one another at the edges. This procedure is possible without the use of a tool and can therefore be realized with very little effort. The small load carriers can be arranged directly adjacent to one another or laterally spaced apart.

Due to the presence of the connecting recesses and connecting protrusions on the edge of the respective base plate, it is only substantially rectangular in design, not mathematically exactly rectangular. At least one base plate can also be designed to be square, for example. In particular, the base plates can be designed with the same or different rectangular shapes.

The fact that the connecting recesses and connecting projections of the respective base plate are arranged around the edge in at least indirect alternation means that either the respective connecting recess is immediately followed by a connecting projection or that an edge portion of the base plate is arranged between the connecting recess and the connecting projection, such that the connecting projection only indirectly follows the connecting recess.

The connecting recesses and connecting projections of the base plates can be designed in such a manner that the base plates, which are connected to one another at their edges in a form-fitting manner, cannot be separated from one another in their plane of extension, which makes the base formed with the base system according to the invention more robust. To separate the base plates from one another, at least one of the base plates must first be displaced transversely to the plane in which it extends, such that the form closure between the base plates is released and the base plates can be separated from one another.

As opposite sides of the respective base plate are designed to complement one another, identically designed base plates can be arranged in a row with or without offset and connected to one another.

In accordance with an advantageous embodiment, at least one connecting recess is designed in a dovetail shape and at least one connecting projection is designed in a complementary dovetail shape. This allows a form closure to be produced between the base plates, which prevents the two base plates, which are connected to one another in a form-fitting manner, from separating in their plane of extension, which makes the base formed by the base plates or the base system more robust.

In accordance with a further advantageous embodiment, the base plates are designed identically. This means that the base plates are identical parts and can therefore be produced cost-effectively in large quantities.

In accordance with a further advantageous embodiment, at least one securing recess for securing a small load carrier placed on the base plate against slipping relative to the base plate is designed on an upper side of at least one base plate facing away from the small load carrier. The recess can, for example, be designed as a blind hole or as a perforation that completely penetrates the base plate, particularly a through-hole.

In accordance with a further advantageous embodiment, at least one perforation is designed in the center of at least one base plate, through which a handle portion of the base plate, which is monolithically connected to the rest of the base plate, extends in the center. The base plate can be gripped and handled by its handle portion, which is arranged in the area of the center of gravity of the base plate, such that the connection of base plates to one another is not hindered by gripping an edge portion of the respective base plate.

In accordance with a further advantageous embodiment, an underside of at least one base plate facing the small load carrier is smaller than the upper side of the base plate. This allows the underside of the base plate to be inserted into the receiving opening of a small load carrier, while the upper side of the base plate protrudes beyond the upper side of the small load carrier in the area of the connecting protrusions. This secures the base plate against slipping in relation to the small load carrier. There is preferably a predetermined clearance between the underside of the base plate and the circumferential side wall of the small load carrier in order to compensate for manufacturing tolerances.

In accordance with a further advantageous embodiment, a circumferential gradation is designed between the upper side and the underside on the edge. The gradation can be formed by a single circumferential step at the edge of the base plate. Alternatively, the base plate can taper continuously from its upper side towards its underside, i.e. be designed conically.

In accordance with a further advantageous embodiment, at least one base plate is at least partially designed as a flat pressed plate. This enables the cost-effective production of a robust and lightweight base plate.

In accordance with a further advantageous embodiment, the flat pressed board is provided with a laminate on one or both sides. This can make the base plate more robust against mechanical or chemical impacts.

A storage system according to the invention for storing objects has at least two small load carriers which can be placed next to one another on a flat underground and at least one base system according to one of the above-mentioned embodiments or a combination of at least two of these embodiments with one another.

The advantages mentioned above with regard to the base system are associated with the loading system. The load carriers are preferably standardized small load carriers, particularly Euro boxes.

In accordance with an advantageous embodiment, the respective base plate is larger in the area of the connecting protrusions and smaller in the area of the connecting recesses than the upper side of the respective small load carrier. This makes it possible for a base plate resting on a small load carrier to also be supported on an adjacent small load carrier via its connecting protrusions, which engage in the connecting recesses of an adjacent base plate. This means, for example, that a base plate can also be arranged to float, so to speak, between two small load carriers arranged at a distance from one another, on each of which the base plate rests only with its connecting protrusions.

A further base system according to the invention for placing on at least two standardized small load carriers, particularly Euro boxes, arranged next to one another on a flat underground, has at least two substantially rectangular base plates, wherein each base plate is provided with connecting recesses and connecting projections around the edges, alternating at least indirectly, by means of which the base plates can be connected to one another at the edges in a form-fitting manner, wherein opposite sides of the respective base plate are designed to be complementary to one another, wherein an underside of at least one base plate facing the small load carrier is smaller than the upper side of the base plate, and wherein a circumferential stepping is designed on the edge between the upper side and the underside.

By means of the base system according to the invention, a base, particularly an intermediate base, can be formed on the small load carriers, on which objects, for example further small load carriers, can be placed. In addition, the base designed in this manner can be walked on in such a manner that accessibility to the load space is not impaired by the small load carriers placed on the load space base. This means that the load space partially occupied by the small load carriers can be used more optimally.

To form the base by means of the base system, the base plates are simply placed on the small load carriers and connected to one another at the edges. This procedure is possible without the use of a tool and can therefore be realized with very little effort. The small load carriers can be arranged directly adjacent to one another or laterally spaced apart.

Due to the presence of the connecting recesses and connecting protrusions on the edge of the respective base plate, it is only substantially rectangular in design, not mathematically exactly rectangular. At least one base plate can also be designed to be square, for example. In particular, the base plates can be designed with the same or different rectangular shapes.

The fact that the connecting recesses and connecting projections of the respective base plate are arranged around the edge in at least indirect alternation means that either the respective connecting recess is immediately followed by a connecting projection or that an edge portion of the base plate is arranged between the connecting recess and the connecting projection, such that the connecting projection only indirectly follows the connecting recess.

The connecting recesses and connecting projections of the base plates can be designed in such a manner that the base plates, which are connected to one another at their edges in a form-fitting manner, cannot be separated from one another in their plane of extension, which makes the base formed with the base system according to the invention more robust. To separate the base plates from one another, at least one of the base plates must first be displaced transversely to the plane in which it extends, such that the form closure between the base plates is released and the base plates can be separated from one another.

As opposite sides of the respective base plate are designed to complement one another, identically designed base plates can be arranged in a row with or without offset and connected to one another.

Since the lower side of at least one base plate facing the small load carrier is smaller than the upper side of the base plate, the lower side of the base plate can be inserted into the receiving opening of a small load carrier, while the upper side of the base plate protrudes beyond the upper side of the small load carrier in the area of the connecting protrusions. This secures the base plate against slipping in relation to the small load carrier. Preferably, there is a predetermined clearance between the underside of the base plate and the circumferential side wall of the small load carrier in order to compensate for manufacturing tolerances.

The level designed to run around the edge between the upper side and the underside can be formed by a single circumferential level at the edge of the base plate. Alternatively, the base plate can taper continuously from its upper side towards its underside, i.e. be designed conically.

In accordance with an advantageous embodiment, at least one connecting recess is designed in a dovetail shape and at least one connecting projection is designed in a complementary dovetail shape. This allows a form closure to be produced between the base plates, which prevents the two base plates, which are connected to one another in a form-fitting manner, from separating in their plane of extension, which makes the base formed by the base plates or the base system more robust.

In accordance with a further advantageous embodiment, each base plate is provided around its edge with connecting geometries which are designed in the same manner, are directly adjacent to one another all the way around and are each formed by a first edge portion of the base plate, a connecting recess, a connecting projection and a second edge portion of the base plate in this order, wherein the connecting recess of the respective connecting geometry is directly adjacent to the connecting projection of this connecting geometry. This special geometric design of the base plates is easy to produce and enables the above-mentioned advantages of the invention in a special manner.

In accordance with a further advantageous embodiment, the base plates are designed identically. This means that the base plates are identical parts and can therefore be produced cost-effectively in large quantities.

In accordance with a further advantageous embodiment, at least one securing recess for securing a small load carrier placed on the base plate against slipping relative to the base plate is designed on an upper side of at least one base plate facing away from the small load carrier. The recess can, for example, be designed as a blind hole or as a perforation that completely penetrates the base plate, particularly a through-hole.

In accordance with a further advantageous embodiment, at least one perforation is designed in the center of at least one base plate, through which a handle portion of the base plate, which is monolithically connected to the rest of the base plate, extends in the center. The base plate can be gripped and handled by its handle portion, which is arranged in the area of the center of gravity of the base plate, such that the connection of base plates to one another is not hindered by gripping an edge portion of the respective base plate.

In accordance with a further advantageous embodiment, at least one base plate is at least partially designed as a flat pressed plate. This enables the cost-effective production of a robust and lightweight base plate.

In accordance with a further advantageous embodiment, the flat pressed board is provided with a laminate on one or both sides. This can make the base plate more robust against mechanical or chemical impacts.

A further storage system according to the invention for storing objects has at least two small load carriers which can be placed next to one another on a flat underground and at least one base system according to one of the above-mentioned embodiments or a combination of at least two of these embodiments with one another.

The advantages mentioned above with regard to the base system are associated with the loading system. The load carriers are preferably standardized small load carriers, particularly Euro boxes.

In accordance with an advantageous embodiment, the respective base plate is larger in the area of the connecting protrusions and smaller in the area of the connecting recesses than the upper side of the respective small load carrier. This makes it possible for a base plate resting on a small load carrier to also be supported on an adjacent small load carrier via its connecting protrusions, which engage in the connecting recesses of an adjacent base plate. This means, for example, that a base plate can also be arranged to float, so to speak, between two small load carriers arranged at a distance from one another, on each of which the base plate rests only with its connecting protrusions.

### BRIEF DESCRIPTION OF THE DRAWINGS

In the following, the invention is explained by way of example with reference to the attached figures with reference to preferred embodiments, wherein the features mentioned below can represent an advantageous and/or further-forming aspect of the invention both individually and in different combinations with one another. Shown in the drawings:

FIG. 1A shows a schematic top view of an upper side of an exemplary embodiment of a base plate according to the invention;

FIG. 1B shows a schematic top view of an underside of the base plate shown in FIG. 1A;

FIG. 2A shows a schematic top view of an upper side of a further exemplary embodiment of a base plate according to the invention;

FIG. 2B shows a schematic top view of an underside of the base plate shown in FIG. 2A;

FIG. 3A shows a schematic top view of an upper side of a further exemplary embodiment of a base plate according to the invention;

FIG. 3B shows a schematic top view of an underside of the base plate shown in FIG. 3A;

FIG. 4A shows a schematic top view of an upper side of an exemplary embodiment of a base plate according to the invention;

FIG. 4B shows a schematic top view of an underside of the base plate shown in FIG. 4A;

FIG. 5A shows a schematic top view of an upper side of a further exemplary embodiment of a base plate according to the invention;

FIG. 5B shows a schematic top view of an underside of the base plate shown in FIG. 5A;

FIG. 6A shows a schematic top view of an upper side of a further exemplary embodiment of a base plate according to the invention;

FIG. 6B shows a schematic top view of an underside of the base plate shown in FIG. 6A;

FIG. 7 shows a schematic diagram and perspective view of an exemplary embodiment of a storage system according to the invention;

FIG. 8 shows a schematic diagram and perspective view of a further exemplary embodiment of a storage system according to the invention;

FIG. 9a shows a schematic diagram and perspective view of a further exemplary embodiment of a storage system according to the invention;

FIG. 9b shows a further schematic diagram and perspective representation of the storage system shown in FIG. 9a;

FIG. 10a shows a schematic diagram and perspective representation of details of a further exemplary embodiment of a storage system according to the invention;

FIG. 10b shows a schematic diagram and perspective view of further details of the storage system shown in FIG. 10a; and

FIG. 10c shows a side view of the bearing system shown in FIGS. 10a and 10b.

In the figures, identical or functionally identical components are provided with the same reference signs. A repeated description of such components can be omitted.

### DETAILED DESCRIPTION OF THE INVENTION

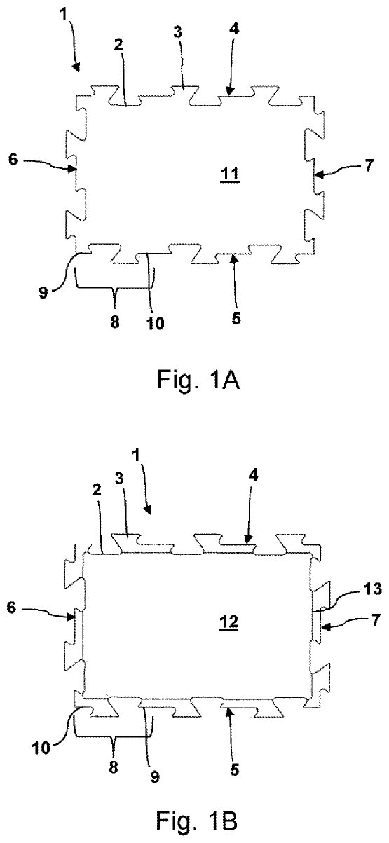

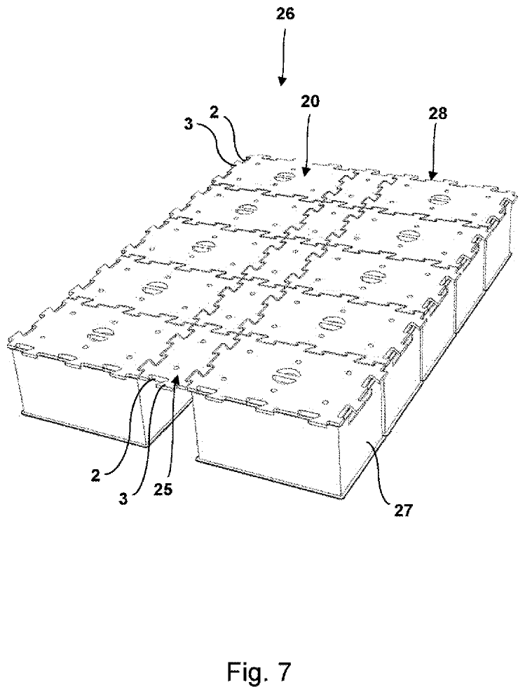

FIG. 1A shows a schematic top view of an upper side 11 of an exemplary embodiment for a base plate 1 according to the invention of a base system, not shown in FIG. 1A, for placing on at least two standardized small load carriers, particularly Euro boxes, which are arranged next to one another on a flat underground and are not shown. The base system can be designed as shown in FIG. 7, for example. Alternatively, the base system can be any combination of at least two base plates (FIG. 1A: 1) according to FIGS. 1A to 6B.

The base plate 1 is substantially rectangular in design, but not square. The base plate 1 is provided with connecting recesses 2 and connecting projections 3 around the edges, alternating at least indirectly, via which the base plates 1 can be connected to one another at the edges in a form-fitting manner, as shown, for example, in FIG. 7. Opposite sides 4 and 5 or 6 and 7 of base plate 1 are designed to complement one another. Each connecting recess 2 is designed in a dovetail shape and each connecting projection 3 is designed in a complementary dovetail shape.

In particular, the base plate 1 is provided all around its edges with connecting geometries 8, which are designed in the same manner, are directly adjacent to one another all around and are each formed by a first edge portion 9 of the base plate 1, a connecting recess 2, a connecting projection 3 and a second edge portion 10 of the base plate 1 in this order. The connecting recess 2 of the respective connecting geometry 8 is directly adjacent to the connecting projection 3 of this connecting geometry 8.

The base plate 1 can be at least partially designed as a flat pressed plate. The flat pressed plate can be provided on one or both sides, i.e. on its large sides, with a laminate not shown.

FIG. 1B shows a schematic top view of an underside 12 of the base plate 1 shown in FIG. 1A. It is shown that the lower side 12 of the base plate 1 facing the small load carrier not shown in FIG. 1B is smaller than the upper side of the base plate 1 shown in FIG. 1A. For this purpose, a circumferential step 13 is designed on the edge between the upper side and the lower side 12.

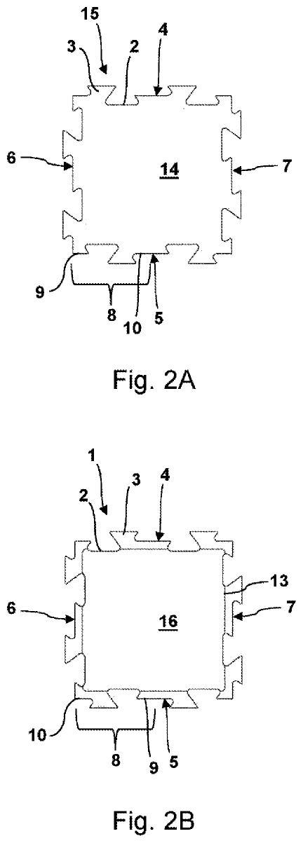

FIG. 2A shows a schematic top view of an upper side 14 of a further exemplary embodiment for a base plate 15 according to the invention. The base plate 15 differs from the exemplary embodiment shown in FIGS. 1A and 1B solely in that the base plate 15 is designed to be square. To avoid repetition, reference is therefore made to the above description of FIGS. 1A and 1B.

FIG. 2B shows a schematic top view of an underside 15 of the base plate 15 shown in FIG. 2A. To avoid repetition, reference is therefore made to the above description of FIG. 1B.

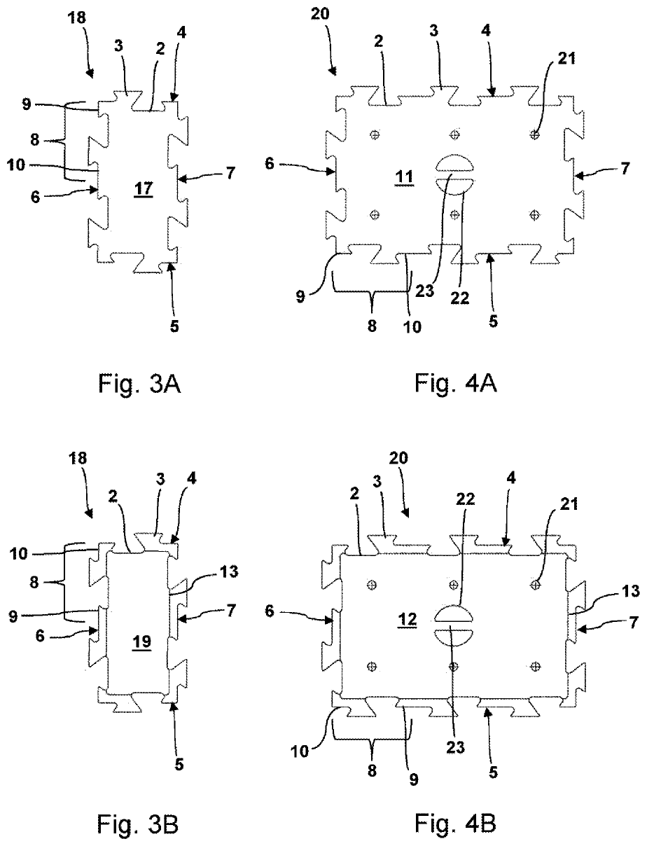

FIG. 3A shows a schematic top view of an upper side 17 of a further exemplary embodiment for a base plate 18 according to the invention. The base plate 18 differs from the exemplary embodiment shown in FIGS. 2A and 2B solely in that, although the base plate 18 is rectangular and not square, it is designed to be half the size of the exemplary embodiment shown in FIGS. 2A and 2B. To avoid repetition, reference is therefore made to the above description of FIGS. 1A and 1B.

FIG. 3B shows a schematic top view of an underside 19 of the base plate 18 shown in FIG. 3A. To avoid repetition, reference is therefore made to the above description of FIG. 1B.

FIG. 4A shows a schematic top view of an upper side 11 of an exemplary embodiment for a base plate 20 according to the invention. The base plate 20 differs from the exemplary embodiment shown in FIGS. 1A and 1B in that six securing recesses 21 in the form of through-holes are designed on the upper side 11 of the base plate 20, which faces away from the small load carrier not shown in FIG. 4A, to secure a small load carrier placed on the base plate 20, not shown, against slipping relative to the base plate 20. In addition, the base plate 20 differs from the exemplary embodiment shown in FIGS. 1A and 1B in that a perforation 22 is designed at the center of the base plate 20, through the center of which extends a handle portion 23 of the base plate 20 that is monolithically connected to the rest of the base plate 20. To avoid repetition, reference is therefore made to the above description of FIGS. 1A and 1B.

FIG. 4B shows a schematic top view of an underside of the base plate 20 shown in FIG. 4A. To avoid repetition, reference is therefore made to the above description of FIG. 1B.

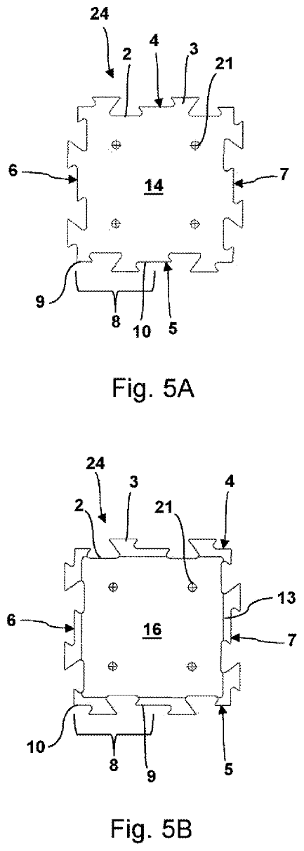

FIG. 5A shows a schematic top view of an upper side 14 of a further exemplary embodiment for a base plate 24 according to the invention. The base plate 24 differs from the exemplary embodiment shown in FIGS. 4A and 4B solely in that the base plate 24 is designed to be square. To avoid repetition, reference is therefore made to the above description of FIGS. 4A and 4B.

FIG. 5B shows a schematic top view of an underside 16 of the base plate 24 shown in FIG. 5A. To avoid repetition, reference is therefore made to the above description of FIG. 1B.

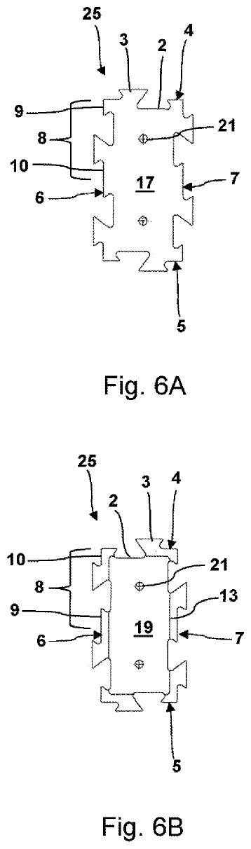

FIG. 6A shows a schematic top view of an upper side 17 of a further exemplary embodiment for a base plate 25 according to the invention. The base plate 25 differs from the exemplary embodiment shown in FIGS. 5A and 5B solely in that, although the base plate 25 is rectangular and not square, it is designed to be half the size of the exemplary embodiment shown in FIGS. 5A and 5B. To avoid repetition, reference is therefore made to the above description of FIGS. 1A and 1B.

FIG. 6B shows a schematic top view of an underside 19 of the base plate 25 shown in FIG. 6A. To avoid repetition, reference is therefore made to the above description of FIG. 1B.

FIG. 7 shows a schematic diagram and perspective view of an exemplary embodiment of a storage system 26 according to the invention for storing objects not shown.

The storage system 26 has ten small load carriers 27 in the form of Euro boxes placed on a flat underground not shown. Five small load carriers 27 are arranged in a row, wherein the two rows are laterally spaced apart from one another, leaving an intermediate space. A base plate 20 corresponding to the exemplary embodiment shown in FIGS. 4A and 4B is placed on each small load carrier 27, forming an exemplary embodiment of a base system 28. The respective base plate 20 is larger in the area of the connecting protrusions 3 and smaller in the area of the connecting recesses 2 than an upper side of the respective small load carrier 27.

In each case, two base plates 20 are connected to one another via a base plate 25 in accordance with the exemplary embodiment shown in FIGS. 6A and 6B, wherein the base plates 25 are also arranged in a row and connected to one another in pairs. The base plates 25 rest on the respective small load carrier 27 with their connecting projections 3 engaging in the connecting recesses 2 of the base plates 20. In this manner, a load-bearing, particularly accessible, intermediate base is formed above the small load carriers 27, wherein the intermediate space between the two rows of small load carriers 27 can also be used as storage space.

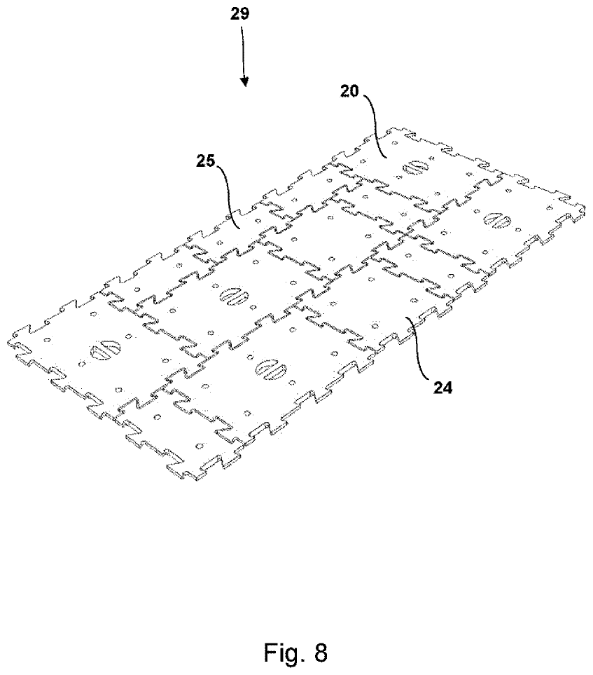

FIG. 8 shows a schematic diagram and perspective view of a further exemplary embodiment of a base system 29 according to the invention for placing on at least two standardized small load carriers, particularly Euro boxes, which are arranged next to one another on a flat underground not shown.

The base system 29 has five base plates 20 according to the exemplary embodiment shown in FIGS. 4A and 4B, six base plates 25 according to the exemplary embodiment shown in FIGS. 6A and 6B, and two base plates according to the exemplary embodiment shown in FIGS. 5A and 5B, which are connected together to form a closed, rectangular surface.

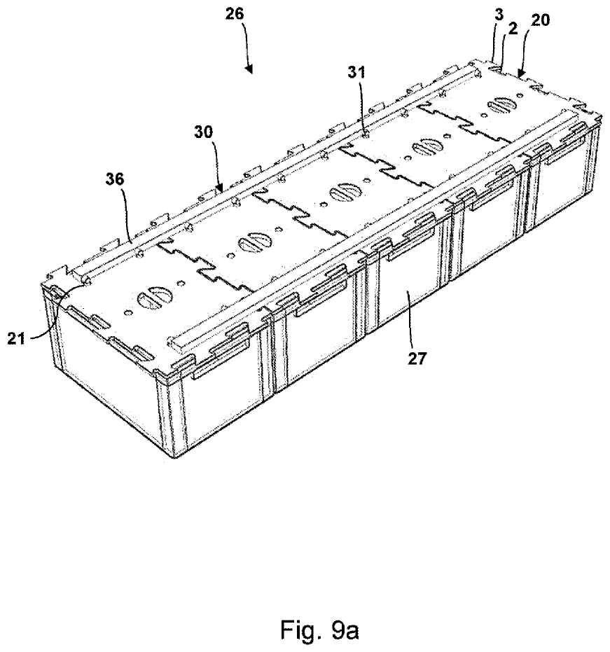

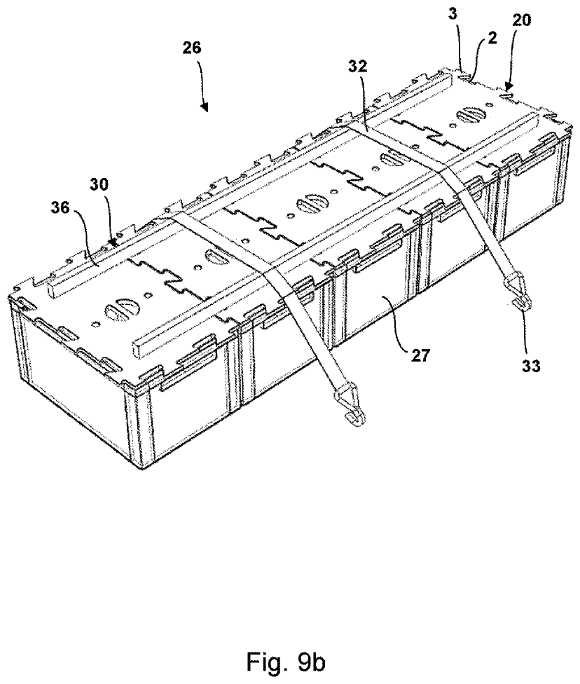

FIG. 9a shows a schematic diagram and perspective view of a further exemplary embodiment of a storage system 26 according to the invention for storing objects.

The storage system 26 has five small load carriers 27 in the form of Euro boxes arranged in a row on a flat underground not shown. A base plate 20 corresponding to the exemplary embodiment shown in FIGS. 4A and 4B is placed on each small load carrier 27. The respective base plate 20 is larger in the area of the connecting protrusions 3 and smaller in the area of the connecting recesses 2 than an upper side of the respective small load carrier 27.

In addition, the storage system 26 has two connecting strips 30 extending parallel to one another, which can be produced from a wooden material, a plastic or a metallic material, for example. Each connecting strip has a rigid strip 36 and ten cylindrical connecting pins 31 arranged in a row on the strip 36, which can be inserted into the securing recesses 21 of the base plates 20 designed as through-holes, as shown in FIG. 9b. Alternatively, all connecting pins 31 of a connecting strip 30 can be curved towards the same side, such that the securing recesses 21 of the base plates 20 designed as through-holes on the base plates 20 by inserting the connecting pins 31 into the arranged connecting strip 30 cannot be lifted vertically from the base plates, which improves the bond between the connecting strip 30 and the base plates 20.

FIG. 9b shows a further schematic diagram and perspective representation of the bearing system 26 shown in FIG. 9a. The connecting pins shown in FIG. 9a are inserted, particularly form-fitting, into the securing recesses 21, whereby the base plates 20 are joined together to form a fixed connection.

In addition, the storage system 26 has two tension belts 32 with tension hooks 33 at the ends, wherein the tension belts 32 are guided over the connecting strips 30.

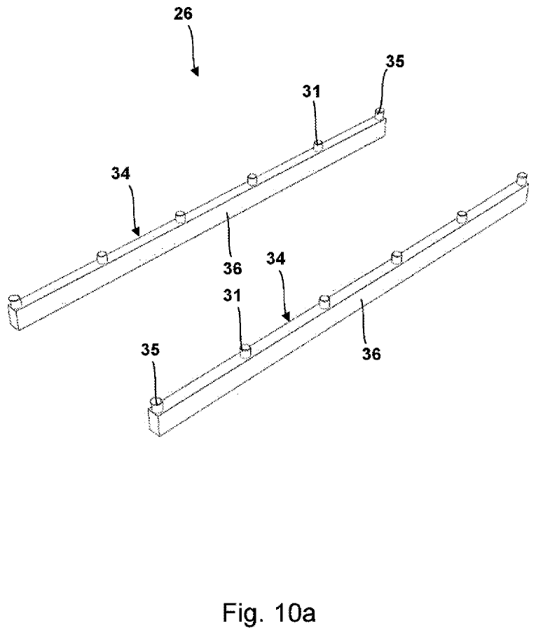

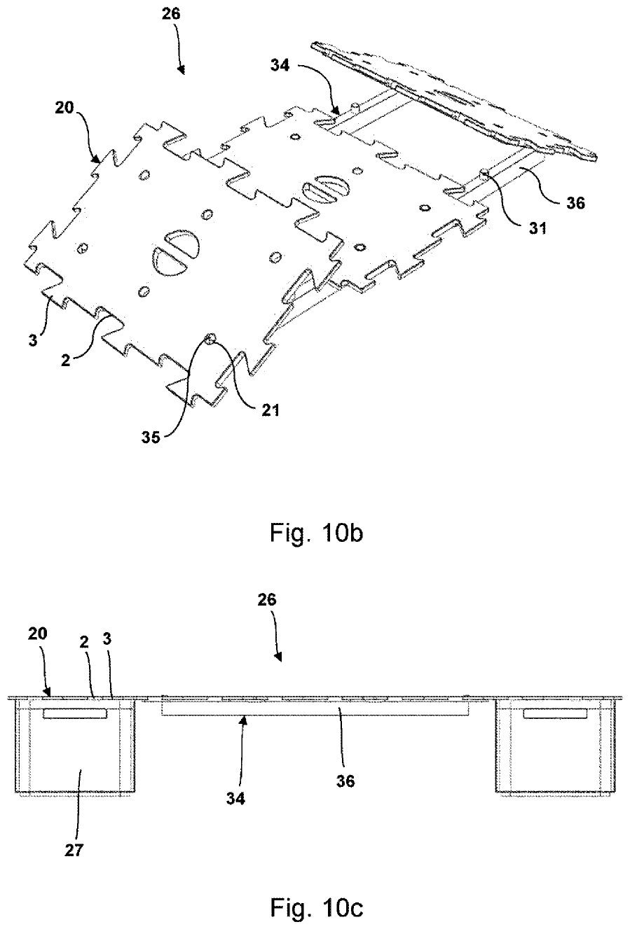

FIG. 10a shows a schematic diagram and perspective view of details of a further exemplary embodiment of a storage system 26 according to the invention for storing objects.

In FIG. 10a, only two connecting strips 34 are shown of the storage system 26, which extend parallel to one another and each have a rigid strip 36, two connecting pins 35 arranged at the ends of the strip 36 and curved away from one another, and four cylindrically designed connecting pins 31 arranged between them.

FIG. 10b shows a schematic diagram and perspective view of further details of the storage system 26 shown in FIG. 10a. In addition, particularly three base plates 20 corresponding to the exemplary embodiment shown in FIGS. 4A and 4B are shown. The central base plate 20 is already fully connected to the connecting strips 34 by placing the base plate 20 on the connecting strips 34 in such a manner that the cylindrical connecting pins 31 engage in the securing recesses 21 of the base plate 20, which are designed as through-holes. Subsequently, the two outer base plates 20 are connected to the connecting strips 34 by first inserting the curved connecting pins 35 into the securing recesses 21 designed as through-holes in the respective base plate 20, as shown in FIG. 10b. The base plates 20 are arranged at an angle. The inclined base plates 20 can then be lowered in such a manner that the outer connecting pins 31 engage in the securing recesses 21 designed as through-holes in the respective base plate 20, as shown in FIG. 10c. This forms a bond between the connecting strips 34 and the base plates 20, which can only be released in a certain manner and is therefore secured against unintentional release.

FIG. 10c shows a side view of the bearing system 26 shown in FIGS. 10a and 10b. Two additional small load carriers 27 of the storage system 26 in the form of Euro boxes are shown. A base plate 20 is arranged on each small load carrier 27. Between the two small load carriers 27 is the connection formed by the connecting strips 34 and the three base plates 20 as shown in FIG. 10b, which is connected at the end to the base plate 20 resting on the respective small load carrier 27. With the storage system 26 shown in FIGS. 10a to 10c, it is therefore possible to bridge a greater distance between small load carriers 27 in order to be able to form a desired loading floor and at the same time keep the space between the spaced-apart small load carriers 27 usable.

### LIST OF REFERENCE SIGNS

1 Base plate
2 Connecting recess
3 Connecting projection
4 Side of 1, 15, 18, 20, 24, 25
Side of 1, 15, 18, 20, 24, 25
6 Side of 1, 15, 18, 20, 24, 25
7 Side of 1, 15, 18, 20, 24, 25
8 Connecting geometry on 1, 15, 18, 20, 24, 25
9 First edge portion
10 Second edge portion
11 Upper side of 1, 20
12 Underside of 1, 20
13 Gradation
14 Upper side of 15, 24
15 Base plate
16 Underside of 15, 24
17 Upper side of 18, 25
18 Base plate
19 Underside of 18, 25
20 Base plate
21 Securing recess
22 Perforation
23 Handle portion
24 Base plate
25 Base plate
26 Storage system
27 Small load carrier
28 Base system
29 Base system
30 Connecting strip
31 Cylindrical connecting pin
32 Tension belt
33 Tension hook
34 Connecting strip
35 Curved connecting pin
36 Strip

What is claimed is:

1. A base system for placing on at least two standardized small load carriers arranged next to one another on a flat subsurface, in particular Euro containers, the base system comprising:
at least two substantially rectangular base panels, wherein each base panel provided with connection recesses and connection protrusions around the edge in an at least indirectly alternating manner, via which recesses and protrusions the base panels can be connected to one another at the edges in a form-fitting manner, mutually facing sides of the relevant base panel being designed to be complementary to one another, each base panel being provided with connection geometries around the edge, which geometries are identical and directly adjoin one another in a peripheral manner, and each connection geometry being formed by a first edge portion of the base panel, a connection recess, a connection protrusion, and a second edge portion of the base panel in this order, the connection recess of the relevant connection geometry directly adjoining the connection protrusion of said connection geometry.

2. The base system according to claim 1, wherein at least one connection recess is designed to be dovetail-shaped and at least one connection protrusion is designed to be dovetail-shaped in a complementary manner thereto.

3. The base system according to claim 1, wherein the base panels are identical.

4. The base system according to claim 1, wherein at least one securing recess for securing a small load carrier placed on the base panel against slipping relative to the base panel is formed on an upper face of at least one base panel, which faces away from the small load carrier.

5. The base system according to claim 1, wherein at least one perforation is formed centrally on at least one base panel, through which a handle portion of the base panel, which is monolithically connected to the remaining base panel, extends centrally.

6. The base system according to claim 1, wherein a lower face of at least one base panel, which faces the small load carrier, is smaller than an upper face of the base panel.

7. The base system according to claim 6, wherein a peripheral gradation is formed at the edge between the upper face and the lower face.

8. The base system according to claim 1, wherein at least one base panel is at least partially designed as a flat pressed panel.

9. The base system according to claim 8, wherein the flat pressed panel is provided with a laminate on one or both sides.

10. A storage system for storing objects, comprising:
at least two small load carriers which can be placed next to one another on a flat subsurface, and
at least one base system according to claim 1.

11. The storage system according to claim 10, wherein the relevant base panel has larger dimensions in the region of the connection protrusions and smaller dimensions in the region of the connection recesses than an upper face of the relevant small load carrier.

12. A base system for placing on at least two standardized small load carriers arranged next to one another on a flat subsurface, in particular Euro containers, the base system comprising:
at least two substantially rectangular base panels, wherein each base panel is provided with connection recesses and connection protrusions around the edge in an at least indirectly alternating manner, via which recesses and protrusions the base panels can be connected to one another at the edges in a form-fitting manner, mutually facing sides of the relevant base panel being designed to be complementary to one another, and a lower face of at least one base panel, which faces the small load carrier, being smaller than the upper face of the base panel, a peripheral gradation being formed at the edge between the upper face and the lower face.

13. The base system according to claim 12, at least one connection recess is designed to be dovetail-shaped and at least one connection protrusion is designed to be dovetail-shaped in a complementary manner thereto.

14. The base system according to claim 12, wherein each base panel is provided with connection geometries around the edge, which geometries are identical, directly adjoin one another in a peripheral manner, and are in each case formed by a first edge portion of the base panel, a connection recess, a connection protrusion, and a second edge portion of the base panel in this order, the connection recess of the relevant connection geometry directly adjoining the connection protrusion of said connection geometry.

15. The base system according to claim 12, wherein the base panels are identical.

16. The base system according to claim 12, wherein at least one securing recess for securing a small load carrier placed on the base panel against slipping relative to the base panel is formed on an upper face of at least one base panel, which faces away from the small load carrier.

17. The base system according to claim 12, wherein at least one perforation is formed centrally on at least one base panel, through which perforation a handle section of the base panel, which is monolithically connected to the remaining base panel, extends centrally.

18. The base system according to claim 12, wherein at least one base panel is formed at least partially as a flat pressed panel.

19. (canceled)

20. A storage system for storing objects, comprising:
at least two small load carriers which can be placed next to one another on a flat subsurface, and
at least one base system according to claim 12.

21. The storage system according to claim 20, wherein the relevant base panel has larger dimensions in the region of the connection protrusions and smaller dimensions in the region of the connection recesses than an upper face of the relevant small load carrier.
